(19) United States
(12) Patent Application Publication
(10) Pub. No.: US 2010/0302128 A1
(43) Pub. Date: Dec. 2, 2010

(54) ELECTRONIC APPARATUS

(76) Inventor: Ming-Te Lin, Taipei (TW)

Correspondence Address: NORTH AMERICA INTELLECTUAL PROPERTY CORPORATION, P.O. BOX 506, MERRIFIELD, VA, 22116, US

(21) Appl. No.: 12/777,253

(22) Filed: May 10, 2010

(30) Foreign Application Priority Data
May 27, 2009 (TW) 098117686

(51) Int. Cl. G09G 5/00

(52) U.S. Cl. 345/1.3

(57) ABSTRACT

An electronic apparatus includes a first body comprising a first display area for displaying a first display image, a first sensor disposed in the first body for detecting a first curvature of the first body, and a control module disposed in the first body and electrically connected to the first sensor. When the first body is curved, the first sensor is used to generate a first sensing signal according to the first curvature, and the control module is used to execute a first function according to the first sensing signal.

### BACKGROUND OF THE INVENTION

1. Field of the Invention

The present invention relates to electronic apparatuses, and particularly to an electronic apparatus with a new mode of operation.

2. Description of the Prior Art

Electronics technology changes on a daily basis with new advances and innovations in technology. Displays for consumer electronics products have progressed from black and white to full color, and from large, heavy cathode-ray tube (CRT) displays to thin, light liquid crystal displays (LCDs). To reduce global waste of natural resources, electronic paper is even being developed as a medium for replacing pulp-based paper products.

Electronic paper is a type of display that is light and thin, which can be rolled and/or bent without affecting an image being displayed on the electronic paper. Electronic paper provides users with a convenient medium for reading and browsing information required by the user through wired or wireless transmission. Further, electronic paper display platforms also have touch-recognition input functions for receiving character input. Touch-recognition allows the user to perform control functions, e.g. back and forward browsing functions, through direct touch. The user may also use touch-recognition to perform text editing functions, such as composition and revision. Although electronic paper is very thin, it is capable of storing a large amount of digital book information. Thus, electronic paper is fully capable of reducing traditional paper use.

Although browsing functions may be performed through touch-recognition in electronic paper displays, some users miss the realistic feel of turning a page. It is likely that the absence of page turning affects the user's decision to purchase and use electronic paper products.

### SUMMARY OF THE INVENTION

According to an embodiment, an electronic apparatus comprises a first body comprising a first display area for displaying a first display image, a first sensor disposed in the first body for detecting a first curvature of the first body, and a control module disposed in the first body and electrically connected to the first sensor. When the first body is curved, the first sensor is used to generate a first sensing signal according to the first curvature, and the control module is used to perform a first function according to the first sensing signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic apparatus according to an embodiment of the present invention.

FIG. 2 is a diagram illustrating curving of a leftmost edge region of the first body of the electronic apparatus in a direction from X to Y.

FIG. 3 is a diagram illustrating an electronic apparatus according to another embodiment.

FIG. 4 is a diagram illustrating curving of the electronic apparatus of FIG. 3 in the direction from X to Y.

### DETAILED DESCRIPTION

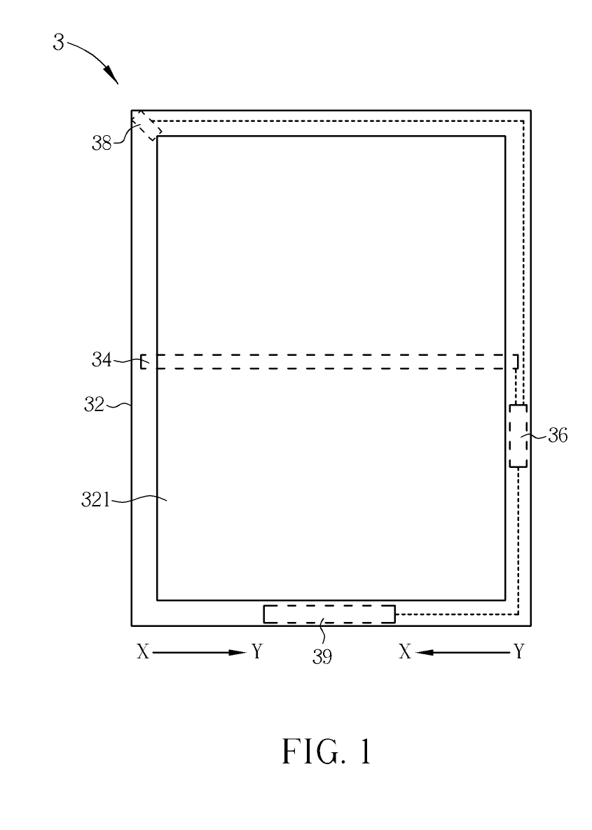

Please refer to FIG. 1, which is a diagram illustrating an electronic apparatus 3 according to an embodiment of the present invention. The electronic apparatus 3 may comprise a first body 32, a first sensor 34, and a control module 36. The electronic apparatus 3 may be integrated with a soft display for displaying images. The electronic apparatus 3 may be an electronic book (e-book) reader device.

The first body 32 may comprise a first display area 321, and may be formed of a bendable material, such as a plastic material, a metal material, and/or a soft material, so that the first body 32 may bend in response to a received external bending force. A first sensor 34 may be disposed in the first body 32, and may be utilized for sensing a first curvature of the first body 32. A control module 36 may be disposed in the first body 32, and may be electrically connected to the first sensor 34. Please note that wiring layout of the electrical connection between the first sensor 34 and the control module 36 is not limited to that shown in FIG. 1. Position of the control module 36 in the first body 32 is not limited, and may be defined freely by the designer. The control module 36 may comprise an artificial intelligence module, e.g. a neural network module, a fuzzy logic control system, and/or genetic algorithms, without limitation to the above.

The electronic apparatus 3 may comprise a third sensor 38 disposed in an edge region of the first body 32 and electrically connected to the control module 36. Please note that wiring layout of the electrical connection between the third sensor 38 and the control module 36 is not limited to that shown in FIG. 1. Position of the third sensor 38 in the first body 32 is not limited, and may be freely defined by the designer. The first sensor 34 and the third sensor 38 may be bend sensors having elongated strip shape, without limitation to the above.

In the above, interconnections, shapes, and functions of each element of the electronic apparatus 3 are described in detail. Shape, size, length, and position within the third body 32 of the first sensor 34, the third sensor 38, and the control module 36 are not limited, and may be altered by the designer according to requirements. Further, number of sensors disposed within the first body 32 is not limited, and may be increased or decreased according to requirements.

In the following, operation of the electronic apparatus 3 is described in detail.

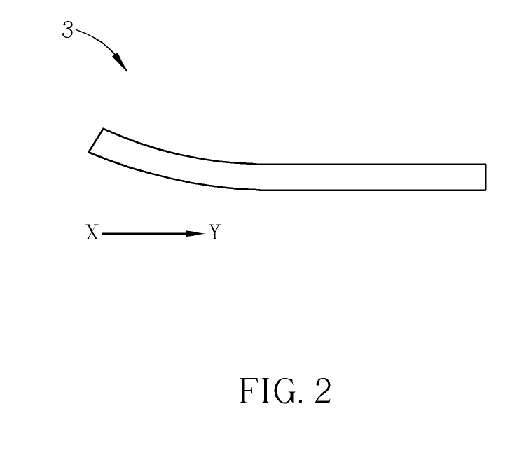

Please refer to FIG. 2 with reference to FIG. 1. FIG. 2 is a diagram illustrating curving of a leftmost edge region of the first body 32 of the electronic apparatus 3 in a direction from X to Y. As shown in FIG. 1 and FIG. 2, the first display area 321 of the electronic apparatus 3 may display information required by the user, e.g. text, digital images, or digital video. When the first body 32 bends up or down in a direction from X to Y, the first display area 321 makes appropriate modifications to displayed content. Similar functionality using similar principles may be applied when a rightmost edge region of the first body 32 of FIG. 1 is bent in a direction from Y to X, so no further description is provided herein.

As an example, please assume that information currently displayed in the first display area 321 is text. When the user is finished reading a page containing the text, and wishes to replace the information displayed in the first display area 321, the user need only execute a page turning motion similar to reading a normal paper book. A bending motion performed on the first body 32, as shown in FIG. 2, may be utilized to turn the page displayed in the first display area 321.

When the first body 32 receives bending force, the first sensor 34 disposed in the first body 32 is also bent. Degree to which the first sensor 34 is bent may be considered a first curvature C1. The first sensor 34 may generate a first sensing signal according to the first curvature, and may send the first sensing signal to the control module 36.

TABLE 1

| First | First Sensing | Bending | Action |
|---|---|---|---|
| Curvature (°) | Signal (mV) | Direction | Performed |
| 10 ≦ C1 < 20 | 1 | X→Y | Advance 2 pages |
| 10 ≦ C1 < 20 | 1 | Y→X | Go back 2 pages |
| C1 ≧ 20 | 2 | X→Y | Advance 4 pages |
| C1 ≧ 20 | 2 | Y→X | Go back 4 pages |

As shown in Table 1, when the first body 32 is bent, if the first curvature C1 sensed by the first sensor 34 is greater than or equal to 10 degrees and less than 20 degrees, the first sensing signal sent to the control module 36 may be a 1 millivolt (mV) signal. When the control module 36 receives the first sensing signal at 1 mV, the control module 36 may calculate and simulate the user's behavior, and perform a page turn. If the first curvature C1 sensed by the first sensor 34 is greater than 20 degrees, the first sensing signal sent to the control module 36 may be a 2 mV signal. When the control module 36 receives the first sensing signal at 2 mV, the control module 36 may calculate and simulate the user's behavior, and perform a first function according to the first sensing signal. For example, the first function may be a page turn, in which a first display image displayed in the first display area 321 of the first body 32 is changed. The first function may also be executing a procedure to turn on or turn off the electronic apparatus 3.

Please note that, because the control module 36 may comprise an artificial intelligence software module, and the artificial intelligence software module may store multiple sets of data corresponding to operation habits of the user, e.g. times of use of the electronic apparatus, times of disuse of the electronic apparatus, and frequently accessed programs of the user (without limitation to the above), the artificial intelligence module may perform grouping and calculation of the above information to output more personalized results.

For example, if the user finishes reading text content of a 20th page, and wishes to turn the page, the user may perform a bending motion on the first body 32 in a direction from X to Y. If the first curvature C1 corresponding to the bending motion is 20 degrees, it can be seen from Table 1 that the control module 36 may receive the first sensing signal as a 2 mV signal with bending in the direction from X to Y. If the above conditions are set internally in the control module 36 to correspond to an output state of advancing four pages from the current page, after the bending motion is executed, the first display area 321 may display content of a 24th page. Please note that the first sensor 34 may generate corresponding output signals according to different bending directions, curvatures, and/or bending positions, all of which may be comprised in the first sensing signal. The above description only describes use of curvature in detail.

If the user does not want to turn so many pages, the user may perform a bending motion on the first body 32 in a direction from Y to X. If the first curvature C1 of the bending motion is 10 degrees, it can be seen from Table 1 that the control module 36 may receive the first sensing signal as a 1 mV signal with bending direction from Y to X. If the above conditions are set internally in the control module 36 to correspond to an output state of going back two pages from the current page, after the bending motion is executed, the first display area 321 may display content of a 22nd page.

If the user does not perform another bending motion for a predetermined length of time, it may represent that the user has successfully turned to the page he/she wishes to view. Thus, the artificial intelligence module may store the first curvature used previously for the page turn in the direction from X to Y, and an output result of how many pages need to be turned corresponding to the first curvature. Thus, it can easily be seen from the above example that, when the user bends the first body 32 in the direction from X to Y with the first curvature of 20 degrees, the user only desires to advance two pages, and not the four pages originally established in Table 1.

The control module 36 may comprise multiple types of artificial intelligence modules, without limitation to a single dimension, even including two or more dimensions, so as to provide an even more appropriate simulation of the user's use patterns for the operation system.

The third sensor 38 disposed in the edge region of the first body 32 may have a different function than the first function described above for the first sensor 34. When the user bends the third sensor 38, the third sensor 38 may generate a third sensing signal, and may send the third sensing signal to the control module 36. After the control module 36 receives the third sensing signal, the control module 36 may perform a third function. The third function may be to mark the first display image, e.g. the page currently displayed. An image of executing marking in the first display area 321 is simultaneously displayed during marking of the first display image. For example, after executing the third function, a corner area of the first display area 321 may display an animation of a folding corner. The control module 36 may perform the corresponding function according to the third sensing signal generated when the third sensor 38 receives bending force. The corresponding function is completely definable by the designer, and is not limited to the application described in the above embodiments.

Each sensor in the first body 32 may not only be used for controlling display output of the first display area 321, but may also be used for controlling electronic control behavior of the first body 32, e.g. turning on and off of the electronic apparatus 3, and driving the electronic apparatus 3 to enter a power saving mode or to wake up. When the first body 32 is rolled up in the direction from X to Y, or in the direction from Y to X, and is held in the rolled up state for a predetermined period of time, e.g. 10 seconds, it may be assumed that the user intends to put away the apparatus, and the control module 36 may shut down the electronic apparatus 3 or put the electronic apparatus 3 in the power saving mode.

TABLE 2

| Operation | Audio Effect |
|---|---|
| Power on | A |
| Next page | B |
| Previous page | C |

The electronic apparatus 3 may further comprise an audio effects module 39. The audio effects module 39 may be disposed in the electronic apparatus 3 (without limitation to specific location within the electronic apparatus 3), and may be electrically connected to the control module 36. Referring to Table 2, the audio effects module 39 may output a corresponding audio effect when the electronic apparatus 3 executes a page turn (to a previous or following page) or turns on. For example, when the electronic apparatus 3 is bent, the control module 36 may receive the sensing signal corresponding to advancing to the next page. At the same time, the control module 36 may also send a signal corresponding to the audio effect B to the audio effects module. This allows the audio effects module 39 to play a corresponding sound while the electronic apparatus 3 is turning the page. The sound played corresponding to each action may also be recorded by the user. Application of the audio effects module 39 described above is only intended as one example, and is not a specific limitation.

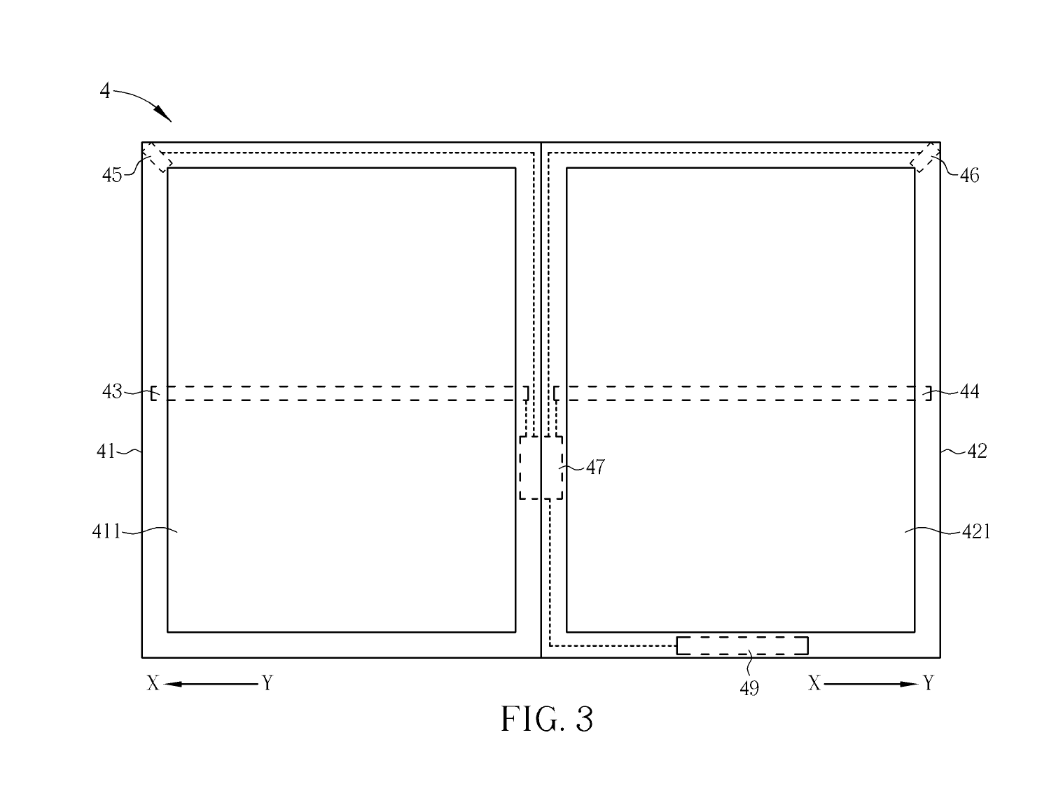

Please refer to FIG. 3, which is a diagram illustrating an electronic apparatus 4 according to another embodiment. As shown in FIG. 3, the electronic apparatus 4 may comprise a first body 41, a second body 42, a first sensor 43, a second sensor 44, a third sensor 45, a fourth sensor 46, a control module 47, and an audio effects module 49. The second body 42 may be connected symmetrically to the first body 41. The first body 41 and the second body 42 may be formed of bendable materials, such as plastic material, metal material, and/or soft material, so that the first body 41 and the second body 42 may curve when receiving an external bending force. The electronic apparatus 4 may be paired with a soft display to display images.

In the embodiment shown in FIG. 3, the first body 41 may comprise a first display area 411, and the second body 42 may comprise a second display area 421. The second display area 421 may display a second display image. The first sensor 43 and the third sensor 45 may be disposed in the first body 41, and may both be electrically connected to the control module 47. Please note that wiring layouts of the electrical connections between the first sensor 43 and the control module 47, and the third sensor 45 and the control module 47, are not limited to those shown in FIG. 3.

The second sensor 44 and the fourth sensor 46 may be disposed in the second body 42, and may both be electrically connected to the control module 47. Please note that wiring layouts of the electrical connections between the second sensor 44 and the control module 47, and the fourth sensor 46 and the control module 47, are not limited to those shown in FIG. 3. Position of the control module 47 is not limited, and may be defined by the designer. The first sensor 43, the second sensor 44, the third sensor 45, and the fourth sensor 46 may be bend sensors having elongated strip shape, without limitation to the above.

Interconnections between components, component shapes, and component functions of the electronic apparatus 4 are described above. Shape, size, and length of the first sensor 43, the second sensor 44, the third sensor 45, the fourth sensor 46, and the control module 47, and positioning thereof within the first body 41 or the second body 42 are not limited, and may be modified according to the requirements of the designer. Number of sensors disposed in the first body 41 or the second body 42 is also not limited, and may be increased or decreased according to requirements.

Operation of the electronic apparatus 4 may be similar to that of the electronic apparatus 3 described above, so no further description is provided herein. Differences in operation between the electronic apparatus 4 and the electronic apparatus 3 are described in the following.

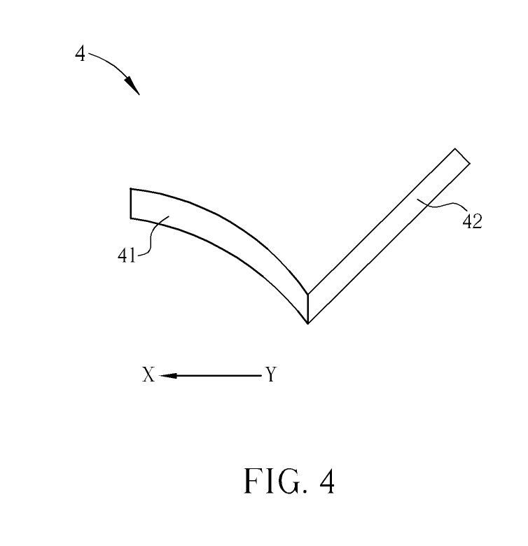

Please refer to FIG. 3 and FIG. 4. FIG. 4 is a diagram illustrating bending of the electronic apparatus 4 of FIG. 3 in the direction from X to Y. As shown in FIG. 4, a leftmost edge of the first body 41 may be bent down by force applied in the direction from Y to X, such that the first body 41 is bent. This function is similar to the bending up of the leftmost edge of the first body 41 by force applied in the direction from X to Y shown in FIG. 2. The electronic apparatus 4 and the electronic apparatus 3 both perform certain functions through the bending method applied. The bending methods, bending curvature, and the corresponding functions may all be defined by the designer, and are not limited herein. The control module 47 in the present embodiment may further comprise the artificial intelligence module, e.g. the neural network module, the fuzzy logic control system, and/or the genetic algorithms, without limitation to the above, so as to learn the operation behavior of the user.

Because the electronic apparatus 4 comprises the first display area 411 and the second display area 421, when the first body 41 or the second body 42 is bent, the first curvature or a second curvature may be generated. The first sensor 43 and the second sensor 44 may generate a first sensing signal and a second sensing signal according to the first curvature and the second curvature, respectively, and may send the first and second sensing signals to the control module 47. The control module 47 may perform the first function or a second function for modifying the first display area 411 and/or the second display area 421 according to the first sensing signal or the second sensing signal received.

The fourth sensor 46 may correspond to functions other than the functions described above. When the user bends the fourth sensor 46, the fourth sensor 46 may generate a fourth sensing signal, which may be sent to the control module 47. After the control module 47 receives the fourth sensing signal, the control module 47 may perform a fourth function, such as a marking function, on the page displayed in the second display area 421, simultaneously displaying a marking function image in the second display area 421. For example, an animated image of a corner being folded may be displayed in a corner area of the second display area 421 after executing the marking function. The control module 47 performs the corresponding function according to the fourth sensing signal generated when the fourth sensor 46 receives bending force. Definition of the fourth function may be freely given to the designer to decide, and is not limited to the above embodiment.

When the user is using the electronic apparatus 4 to view text information, the first display area 411 may display a 21st page, and the second display area 421 may display a 20th page. When the user has finished reading both pages, the user may wish to view a 22nd page. At this time, the user may bend the leftmost edge of the first body 41 downward in the direction from Y to X, thereby generating the first sensing signal. The control module 47 may then advance pages according to the first sensing signal. At this time, the first display area 411 may display a 23rd page, and the second display area 421 may display the 22nd page. Bending of the second body 42 may also correspond to a function. Similar to the abovementioned function, in the present embodiment, the first display area 411 may display the 23rd page, and the second display area 421 may display the 22nd page. After the user finishes reading both pages, the user may wish to view the 21st page. At this time, the user may bend a rightmost edge of the second body 42 downward in the direction from X to Y, thereby generating the second sensing signal. The control module 47 may go back pages according to the second sensing signal. At this time, the first display area 411 may display the 21st page, and the second display area 421 may display the 20th page.

Compared to the prior art, the electronic apparatuses 3, 4 described above provide input control methods different from typical electronic paper or electronic books. Input control of the electronic apparatuses 3, 4 may be similar to the user reading a traditional paper-based book, so that no extra operation training may be required. In addition to completely realizing a true feeling of turning pages while reading, the electronic apparatuses 3, 4 may also output corresponding sounds during page turns or powering on, which may be appealing to the user.

Those skilled in the art will readily observe that numerous modifications and alterations of the device and method may be made while retaining the teachings of the invention.

What is claimed is:

1. An electronic apparatus comprising:
a first body comprising a first display area for displaying a first display image;
a first sensor disposed in the first body for detecting a first curvature of the first body; and
a control module disposed in the first body and electrically connected to the first sensor;
wherein when the first body is curved, the first sensor is used to generate a first sensing signal according to the first curvature, and the control module is used to perform a first function according to the first sensing signal.

2. The electronic apparatus of claim 1, further comprising:
a third sensor electrically connected to the control module and disposed at an edge of the first body;
wherein the third sensor is used to generate a third sensing signal when the third sensor receives a force exerted to bend, and the control module is used to perform a third function according to the third sensing signal.

3. The electronic apparatus of claim 2, wherein the third function is to mark the first display image.

4. The electronic apparatus of claim 2, further comprising:
an audio effects module electrically connected to the control module for generating an audio effect in response to the first sensor or the third sensor receiving a force exerted to bend.

5. The electronic apparatus of claim 1, wherein the first function is to change the first display image.

6. The electronic apparatus of claim 1, wherein the first function is to execute a procedure to turn on or turn off the electronic apparatus.

7. The electronic apparatus of claim 1, wherein the first sensor is an elongated strip.

8. The electronic apparatus of claim 1, wherein the first sensor is a bend sensor.

9. The electronic apparatus of claim 1, wherein the first body is formed by a bendable material.

10. The electronic apparatus of claim 1, further comprising:
a second body comprising a second display area for displaying a second display image, wherein the second body is substantially symmetrically connected to the first body; and
a second sensor disposed in the second body and electrically connected to the control module for sensing a second curvature of the second body;
wherein when the second body is curved, the second sensor is used to generate a second sensing signal according to the second curvature, and the control module is used to perform a second function according to the first sensing signal or the second sensing signal.

11. The electronic apparatus of claim 10, further comprising a fourth sensor electrically connected to the control module and disposed at an edge of the second body, wherein when the fourth sensor receives a force exerted to bend, the fourth sensor is used to generate a fourth sensing signal, and the control module is used to perform a fourth function according to the fourth sensing signal.

12. The electronic apparatus of claim 11, further comprising an audio effects module electrically connected to the control module, for generating an audio effect in response to the first sensor, the second sensor, or the fourth sensor receiving a force exerted to bend.

13. The electronic apparatus of claim 11, wherein the fourth function is to mark the second display image.

14. The electronic apparatus of claim 10, wherein the second function is to change the first display image or the second display image.

15. The electronic apparatus of claim 10, wherein the second sensor is an elongated strip.

16. The electronic apparatus of claim 10, wherein the second sensor is a bend sensor.

17. The electronic apparatus of claim 10, wherein the second body is formed by a bendable material.

18. The electronic apparatus of claim 1, wherein the control module comprises an artificial intelligence module for learning operating behavior of a user of the electronic apparatus.
